(19) United States
(12) Patent Application Publication
(10) Pub. No.: US 2003/0018559 A1
(43) Pub. Date: Jan. 23, 2003

(54) Method of producing and selling popular works of art through the internet

(76) Inventors: Scott Lee Chung, Rolling Hills Estates, CA (US); Ted Lee Chung, Rolling Hills Estates, CA (US); Richard Kon Yoon, Los Angeles, CA (US)

Correspondence Address: Richard Yoon, 2565 Roxy Street, Simi Valley, CA, 93065, US

(21) Appl. No.: 09/768,447

(22) Filed: Jan. 24, 2001

(51) Int. Cl. G06F 17/60

(52) U.S. Cl. 705/37

(57) ABSTRACT

In accordance with the present invention, a method, system, and program for producing a work of art over a network based on popular demand is disclosed. The preferred embodiments collect bids for a work of art wherein the number of bids for the work of art is recorded in a specific project record and the work of art is ordered to be produced if the number of bids for the work of art reaches a minimum number of bids. Moreover, further embodiments obtains a pre-payment or a guarantee for payment for the work of art while collecting bids for the work of art. In addition, further embodiments set a cutoff date by when the number of bids must reach the number of minimum number of bids or cancel the work of art if the cutoff date has been reached and the number of bids for the work of art associated with the project record does not reach the minimum number of bids.

### BACKGROUND OF THE INVENTION

1. Field of the Invention

The method and apparatus of the present invention relate to selling products using electronic networks such as the Internet. In particular, the present invention relates to popular artists directly selling their works of art to their fans by means of the Internet.

2. Description of the Related Art

Popular works of art such as music, books, software, etc. have been distributed primarily through traditional “brick and mortar” retail outlets. Over the past few years, a variety of retailers have set up websites allowing the purchase of such popular works of art via the Internet, and have given consumers confidence in purchasing products on-line. However, the Internet has yet to provide a better means for the artists to take advantage of the Internet revolution. In fact, although transaction costs have decreased for retailers selling over the Internet, the artists have not benefitted. The reason being is that artists still rely on traditional recording labels, publishers, or other establishments to produce their works of art and sell it to their consumers. For example, in the music industry, even in the Internet era, the record labels still organize the promotion and marketing from the top down using traditional methods that are costly and increasingly ineffective. These costs are passed on to artists, (who subsidize, through their own record royalties, a costly, labor-intensive, and non-interactive marketing and promotion infrastructure) and consumers (who pay higher prices without receiving any increase in perceived value). There is a growing dissatisfaction in the artist community with this business model.

Recently, some artists have tried directly producing and selling their products to the consumer by means of the Internet. For example, the artist formerly known as Prince sold his album without the use a recording label by directly selling his album off of his website. However, other artists have been slow to follow his lead. Most artists do not desire to take all the risk without any guarantee of receiving any money. Moreover, most artists lack the sophistication to market and successfully sell their products using the Internet. Given the hurdles of trying to sell their own album off the Internet versus the security of traditional recording contracts, artists have not been able to tap into the Internet revolution. The present invention hopes to overcome the current deficiencies in the prior means of doing business. The present invention hopes to be able to provide artists an alternative method of distributing music and creating revenue which, thus far, has not existed. This new method of distribution can be more profitable for artist, and more tailored made for the consumers, resulting in an economic model that may change the way popular works of art are produced and sold.

### SUMMARY OF THE PREFERRED EMBODIMENTS

The preferred embodiments provide a method, system and program for producing a work of art over a network based on popular demand from a minimum number of bids from users. The preferred embodiments collect bids for a work of art wherein the number of bids for the work of art is recorded in a specific project record and the work of art is ordered to be produced if the number of bids for the work of art reaches the minimum number of bids. Moreover, further embodiments obtains a prepayment or a guarantee for payment for the work of art while collecting bids for the work of art. In addition, further embodiments set a cutoff date by when the number of bids must reach the number of minimum number of bids or cancels the work of art if the cutoff date has been reached and the number of bids for the work of art associated with the project record does not reach the minimum number of bids.

The preferred embodiments allow the artist to produce art based on existing demand. Advantages of the preferred embodiments include improved efficiency between the artist and the consumer, lower overhead costs in producing and marketing works of art, and guaranteed money for artist.

### BRIEF DESCRIPTION OF THE DRAWINGS

Referring now to the drawings in which like reference numbers represent corresponding parts throughout:

FIG. 1 illustrates a network computing environment in which preferred embodiments are implemented;

FIG. 2 illustrates a computing environment of a server in accordance with preferred embodiments of the present invention;

FIG. 3 illustrates files in a user record and a project record in accordance with preferred embodiments of the present invention;

FIG. 4 illustrates a program flow implemented in the server to allow the user to register a Simple Registration;

FIG. 5 illustrates a program flow implementation in the server to allow the user to register for a Full Registration;

FIG. 6 illustrates a program flow implemented in the server for the payment process according to the preferred embodiments of the present invention;

FIG. 7 illustrates a program flow implemented in the server to determine whether to produce the work of art project in accordance with preferred embodiments of the present invention; and

FIG. 8 illustrates an alternative program flow implemented in the server to determine whether to produce the work of art project in accordance with preferred embodiments of the present invention; and

FIG. 9 illustrates a program flow implemented in the server to fulfill the Delivery Process in accordance with preferred embodiments of the present invention.

### DETAILED DESCRIPTION OF THE PREFERRED EMBODIMENTS

The preferred embodiments are directed to a method, system and program for consumers to order works of art directly from the artist. The preferred embodiments pools together users that are fans of a particular artist, and creates an immediate demand for the artist to produce another work of art (i.e. album, book, etc.). This is done by the users committing money up-front to “coproduce” the work of art and in return being the first to receive the work of art as well as receiving co-producer recognition. Thus, the preferred embodiments creates a community of users and artists where users incentivize artists to produce a work of art by guaranteeing a certain amount of money, facilitating greater efficiency, cost savings, and potentially more profits for the artists than traditional methods of production.

In the following description, reference is made to the accompanying drawings which form a part hereof and which illustrate the preferred embodiment of the present invention. It is understood that other embodiments may be utilized and structural and operational changes may be made without departing from the scope of the present invention.

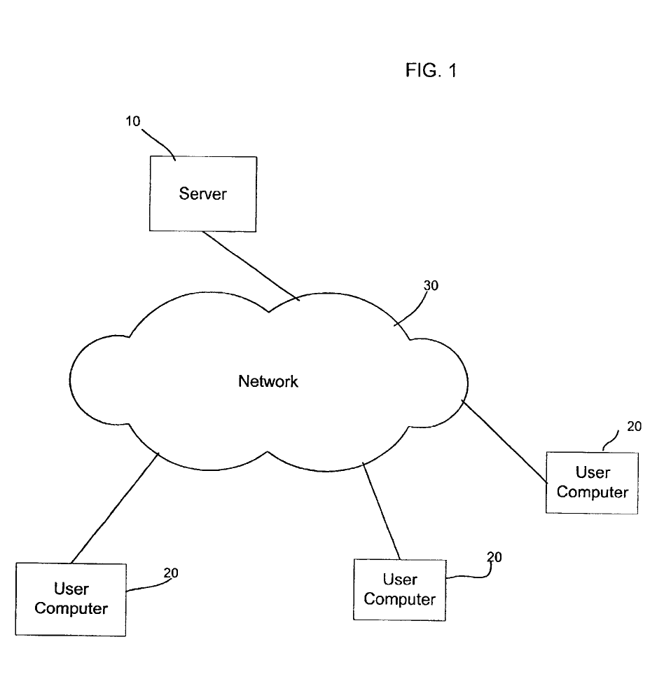

FIG. 1 is a schematic overview diagram of the network computing environment in which the preferred embodiments are implemented. In preferred embodiments, a server 10 and user computers 20 are linked together using a network 30, such as the Internet. The network 30 may be comprised of any network system known in the art including TCP/IP based networks (e.g., an Intranet, the Internet), LAN, Ethernet, WAN, Token Ring, etc. Alternatively, there may be separate and different networks between the components. Further, because the preferred embodiment of the network 30 is the Internet, there can be numerous users using the network 30 simultaneously, however only three user computers 20 are shown for illustration purposes.

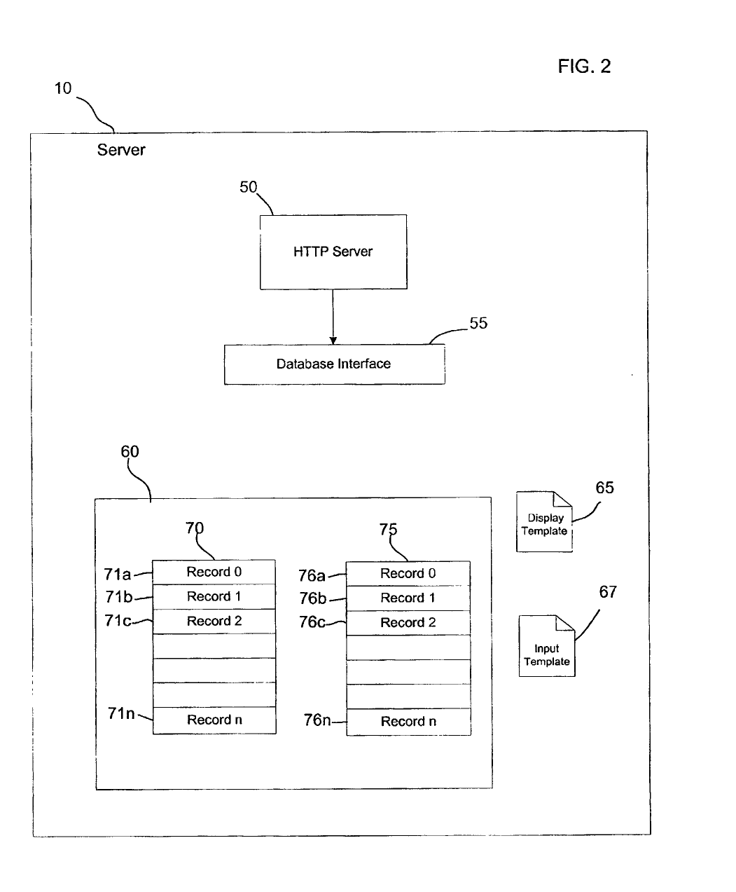

FIG. 2 illustrates software components in the preferred embodiment of server 10, including a Hypertext Transfer Protocol (HTTP) server 50, database 60, database interface 55 and templates 65 and 67. The HTTP server 50 responds to requests from the user computers 20 using HTTP client programs, such as web browser programs known in the art. Upon accessing the server 50 through the network 30 using a unique network address, such as an IP address, the database interface 55 will give specific access to database 60 depending on the secured identification provided by the user computers (i.e. unique username and password.)

The database 60 keeps current, accurate information about the users and the various works of art in the production process. The database 60 comprises a database program known in the art, such as a relational database program. In the preferred embodiment, the database 60 includes two database tables, user database table 70 and project database table 75. User database table 70 includes user records 71a, b, . . . n which is used in the preferred embodiment to track user information. Project database table 75 includes project records 76a, b, . . . n which is used in the preferred embodiment to track works of art that are available to be produced.

The database interface 55 may comprise a Common Gateway Interface (CGI) program, a Java servlet, or other web page implementation known in the art to present the information in database 60 in a presentable format (e.g. HTML page, etc.). In preferred embodiments, the database interface 55 uses a secured login/password verification for identifying the individual user contacting the HTTP server 50. The assigning of a secured login/password will be explained in greater detail below. The unique identification will allow the database interface 55 to identify which user record 71a, b, . . . n belong to the requesting party and will appropriately give read/write capabilities to the user record 71a, b, . . . n.

The server 10 further stores a display template 65 and an input template 67, which are preferably implemented in a document in which dynamic content may be generated (i.e. HTML, Extended Markup Language (XML) Document, etc.). Differing variations of the display template 65 and input template 67 exists for both user information and info on the various works of art, depending on the information to be displayed or inputted, but a single display template 65 and a single input template 67 are used for illustration purposes in FIG. 2. The display template 65 is used to provide the user computers 20 with specific user information from the database table 70 or information on works of art from the database table 75. The database interface 70 generates data into the display template 65 from one or more of the records 71a, b, . . . n and 76a, b, . . . n in the database 60. The input template 67 includes fields in which the user may enter information to update the user record 76a, b, . . . or n, as well as update the project record 76a, b, . . . n when a purchase is made by the user.

The database 60, display template 65, and input template 67 are preferably stored in a non-volatile storage system, such as one or more hard disk drives, used by the server 10 for storage. The server 10 may load data from the storage system into volatile memory (not shown) when processing.

The server 10 and user computers 20 may comprise any type of computer device known in the art, including server, personal computer, mainframe, workstation, hand held device, etc. Moreover, the server 10 may comprise one or more separate computer systems to run the different program components 50, 55, and 60.

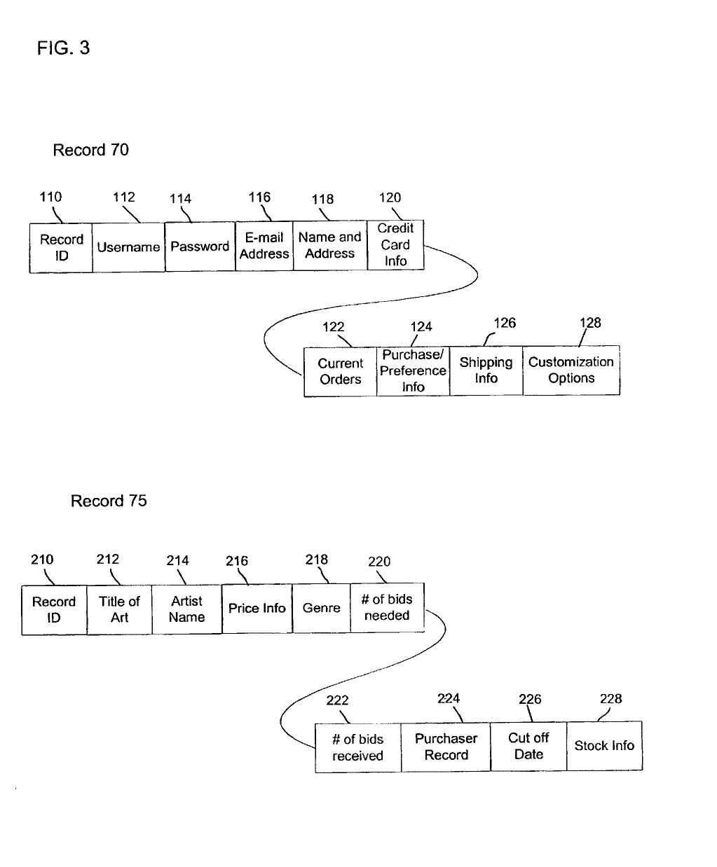

FIG. 3 provides an implementation of the fields in the user records 71a, b, . . . n of the preferred embodiments, which include:

Record ID 110: Provides a unique identifier generated by the database interface 55 for the each unique user.

Username 112: Provides a unique username created by the user that the user uses to login into the member only parts of the URL address.

Password 114: Provides a secret password created by the user used in conjunction with the username in order to access user information and order works of art.

E-mail Address 116: Provides a e-mail address of user.

Address 118: Comprises one or more sub-fields address, telephone, and other contact information of the user.

Credit Card Information 120: Comprises one or more sub-fields indicating the card name, card number, expiration date, billing address, etc.

Current Orders 122: One or more sub-fields set by the database interface 55 indicating the works of art user has committed to produce.

Purchase/Preference Information 124: One or more sub-fields set by database interface 55 providing purchasing history about the user including preferred genre, artist, etc and the interests and preferences listed by the user during the Full Registration Process or Bidding Process.

Shipping Information 126: Comprises one or more sub-fields recording the shipping information selected by the user including the tracking information on the delivery of the completed work of art to the user including method of shipment, carrier, date of shipment and estimated time of arrival (“ETA”).

Customization Options 128: Comprises one or more sub-fields recording customization options selected by the user during the Delivery process.

FIG. 3 also provides an implementation of the fields in the project records 76a, b, . . . n of the preferred embodiments, which include:

Record ID 210: Provides a unique identifier generated by the database interface 55 for the each unique work of art.

Title of Art 212: Provides an identifier for title of the work of art.

Artist Name 214: Provides an identifier name of artist producing work of art.

Price Info 216: Provides cost per unit information about the work of art.

Genre 218: Provides the type of work (i.e. music, book, etc.) and category of genre (rap, rock, country, mystery, horror, etc.).

No. of Bids Needed 220: Provides the preset number of bids needed before the work of art is produced.

No. of Bids Received 222: Provides the number of orders by users to produce the work of art.

Purchaser Record 224: Provides a list of all users ordering the project.

Cutoff Date 226: Provides a date to close the bidding process.

Stock Info 228: Comprises one or more sub-fields recording whether the project has been ordered to be produced by the artist, and if produced, the number of works of art in stock at the warehouse.

Those skilled in the art will appreciate that FIG. 3 is a preferred embodiment of the records 71a, b, . . . n, and 76a, b, . . . n but not as the only implementation. The database tables 70 and 75 can be structured in many alternative formats to accomplish the present invention.

Typically the production process starts when a contract is made between the artist and the website owner to produce a work of art if a certain demand for the work of art is established by the users of the website. The website owner or any other production administrator determines the number of bids and cost per unit of the work of art needed in order for the production to be profitable. The number of bids and cost per unit is determined based on the minimum amount of money the artist agrees to accept to produce the work of art. The cut off date for when the number of orders is required is then set based on the contract terms and/or market analysis. The database administrator then allows the creation of a separate record 76a, b, or n for each work of art in the database 60. The data for the Record ID 210, Title of Art 212, Artist Name. 214, Price Info 216, Genre 218, No. of Bids Needed 222, and Cut off Date 226 is generated and stored in the appropriate work of art record 76a, b, . . . n.

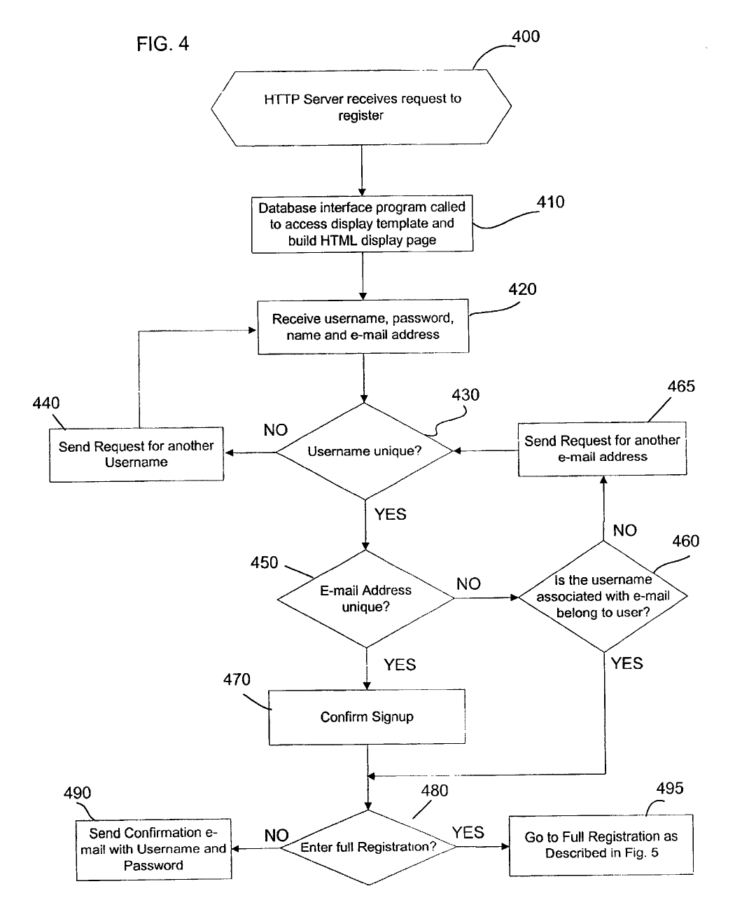

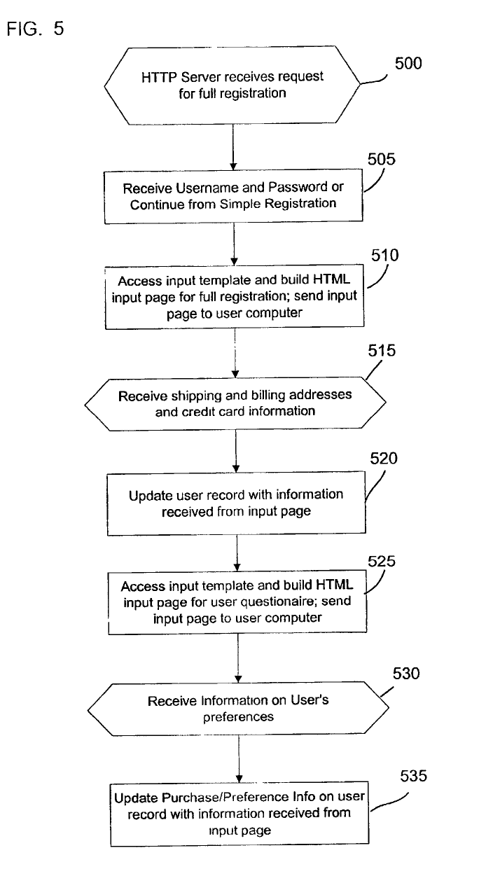

FIGS. 4, 5, 6, 7, 8, and 9 illustrate the program logic embedded in the HTTP server 50 and the database interface 55 to implement the production process of the preferred embodiments. After one or more work of art records 76a, b, . . . n is created, the next step in the preferred embodiments is to create a community of users. FIG. 4 illustrates the program logic to establish a unique user record 71a, b, . . . n with basic user information (“Simple Registration”). At block 400, the HTTP server 50 receives a request from the user to register. At block 410, the database interface 55 accesses the input template 67 and builds an HTML web page querying the user to input username, password, name and e-mail address. The database interface program 55 then receives the inputted username, password, and c-mail (at block 420) and places the information in a new user record 71a, b, . . . n. The database interface 55 then checks the database table 70 to see if the username is unique (at block 430). If the username is already in use by another user record 70a, b . . . or n then at block 440, the database interface 55 accesses the input template 67 and builds an HTML web page requesting the user to input another username. The process is repeated until a unique username is assigned. At block 450, the c-mail address is checked to see if the e-mail entered is unique. If the e-mail address is already in use by another user record 70a, b . . . or n then at block 460, the database interface 55 accesses the input template 67 and builds an HTML web page stating that the e-mail address is associated with an existing username. The user is asked to confirm whether the username belongs to the user by asking for the password associated with the specific user record 71a, b, . . . or n. If the correct password is inputted, the prior user record is used and the new user record deleted. If not, at block 465, the user is queried to input another e-mail address. The process is repeated until a unique e-mail is assigned to the user record 71a, b, . . . or n. At block 470, an e-mail message is sent by the server 10 to confirm the signup by the user. Upon receiving confirmation via e-mail or hypertext link to the confirmation page (not shown), the user will be given an option to register for Full Registration which allows the user to actually bid/order a work of art. If no confirmation is received, the newly created user record will be deleted. At block 480, the database interface 55 will build a HTML web page based on a display template 65 which will list the benefits of full membership. The generated display page may include information such as Title of Art 212, Artist Name 214, and Genre 218 available in database 60. If the user decides not to signup for Full Registration, server 10 sends a confirmation e-mail to user using the E-mail Address 116 associated with the user record 71a, b, . . . or n . . . stating the Username 112 and Password 114 associated with the user record 71a, b, . . . or n. If the Full Registration option is selected, the logic of FIG. 5 is implemented from block 505.

FIG. 5 illustrates the program logic implemented in the HTTP server 50 and database interface 70 to enter additional information into the user record 71a, b, . . . n for Full Membership. In order to sign up of for Full Membership, a user must have already completed the simple registration process having a unique username and password. At block 500, once the user has logged in with his/her unique username and password, or after completing the simple registration, the user will be given the option for Full Membership. At block 505, the HTTP server 50 receives a request from the user for the input page to convert the user record 71a, b, . . . n from the Simple Registration to a Full Membership. In response, the HTTP server 50 requests (at block 510) the database interface 55, which accesses the input template 67 and builds an HTML input page for the specified user record 71a, b, . . . n. The built HTML input page is then sent to the user computer 20, where the user can enter the user's name, shipping address and credit card information, including the card name, card number, expiration date, and billing address associated with the credit card. Although the preferred embodiments use credit cards as the preferred payment option, a check card, debit card, or any other form payment known in the art can be substituted. At block 515, the HTTP server 50 receives the HTML input page with the address and credit card information the user entered. In response, the HTTP server 50 requests the database interface 55 to update (at block 520) the Name/Address field 118 and Credit Card Info field 120 of the relevant record with the information supplied by the user. In the preferred embodiment, the Full Membership process also includes collecting additional information from the user regarding the user's interest and preferences. By receiving the user's preferences in the type of music, books, or other interest, more relevant content can be directed towards the user. After receiving the preference information inputted by the user at block 530, the HTTP server 50 requests the database interface 55 to update (at block 520) the preference information 126 of the relevant record with the information supplied by the user.

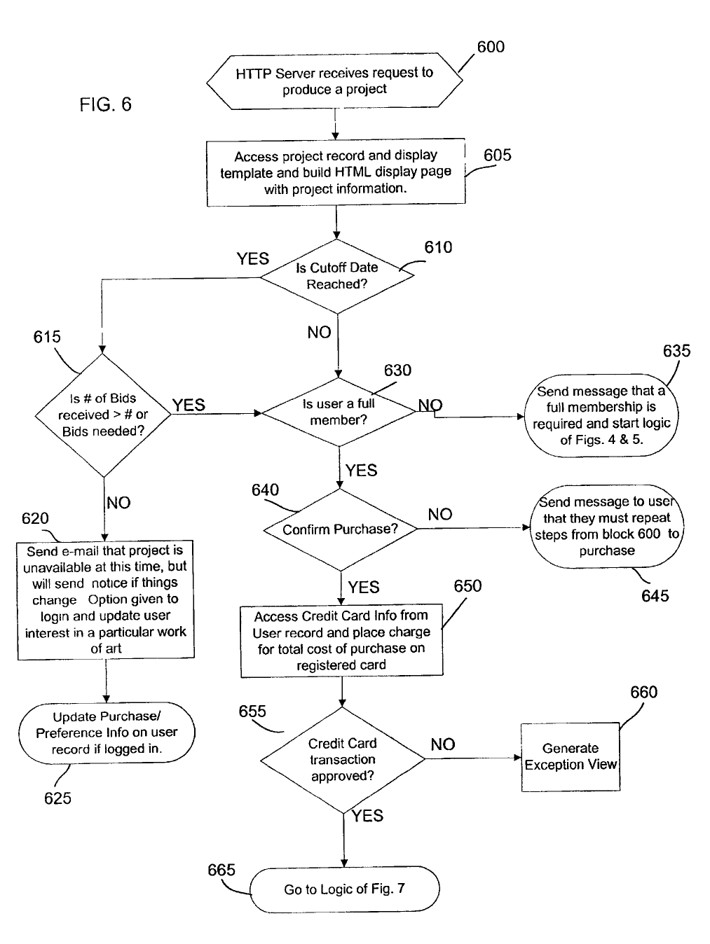

In the preferred embodiments, a user who has signed up for Full Membership can participate in producing a work of art. FIG. 6 illustrates a program flow implemented in the server for the payment process according to the preferred embodiments of the present invention. At block 600, the HTTP server 50 receives a request to produce a work of art listed in the project database table 75. At block 605, the database interface 55 accesses the project record 76a, b, . . . or n for the selected project, and builds an HTML web page using the display template 65 with information recorded in the Artist Name 214, Title of Art 212, and Price Information 216 fields. At block 610, the database interface 55 determines whether the cutoff date has been reached by comparing the server's internal date clock with the date listed in the Cutoff Date field 226. If the cutoff date has been reached, the database interface 55 at block 615 determines whether the number of bids received is greater than the number of bids needed by comparing the two fields Number of Bids Needed 220 and Number of Bids Received 222. If not enough bids were received for the project by the cutoff date, then at block 620, a notice is sent to the user that the project is unavailable at this time, but may be available again at some future date. An option is given to the user to update his record to keep informed of any changes in the future. A user must be logged in to allow the database interface 55 locate the user record 71a, b, . . . or n belonging to the user. Once the user record 71a, b, . . . or n is located by the user logging in, the database interface 55 updates the purchase/preference info field 124 of the user record 71a, b, . . . n to list the particular work of art requested.

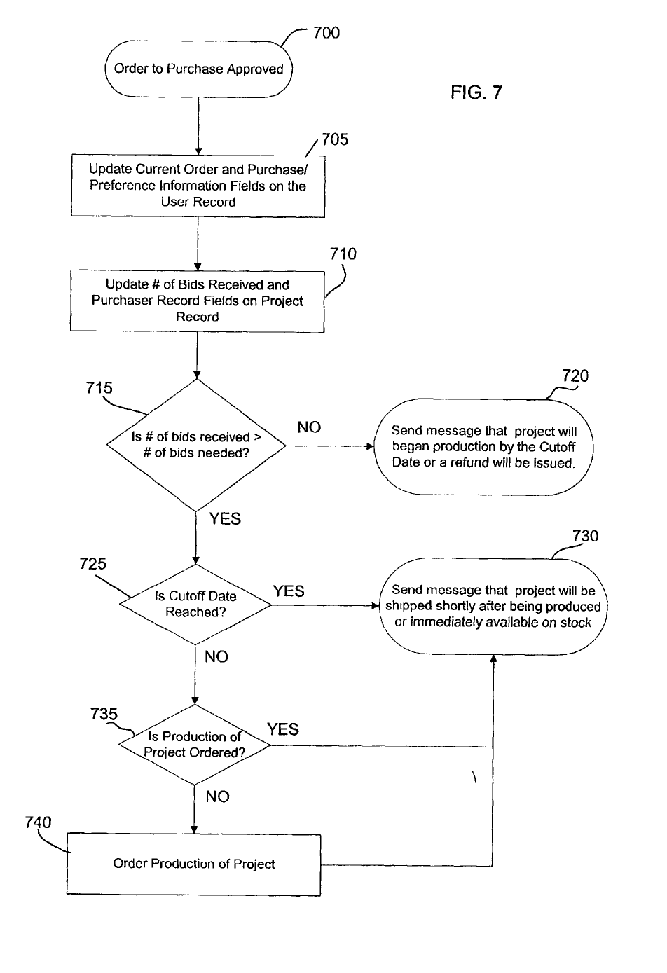

If the cutoff date has not been reached or if the number of bids received is greater than the number of bids needed, the user is given the ability to coproduce the work of art. At block 630, the user is asked to login and the database interface 55 determines whether the user has already signed up for Full Membership. If the user has not previously signed up for Full Membership, the user is told that full membership is required and directed to sign up for Full Membership according to the logic of FIGS. 4 and 5 (at block 635). If the user has previously signed up for Full Membership, then the user is given the option to confirm the purchase quantity and identity of the work of art at block 640. If the user decides not to purchase, then a message is sent by the database interface 55 that the user must start the logic of FIG. 6 again to purchase the work of art, and the logic of FIG. 6 is terminated. If the user confirms the purchase, at block 650, the database interface 55 accesses Credit Card Info field 120 and places a charge for the total cost of the purchase. Alternatively, the database interface 55 can place a hold on the credit card for the entire amount of the purchase. At block 655, the database interface 55 waits until the credit card authorization is received. If the transaction is rejected, an exception view is generated at block 660 asking the user to input another credit card or to check with the user's credit card company. The user is given the opportunity to input new credit card information updating the user record, and retrying the credit card approval process. Once the credit card transaction is approved at block 665, the logic of FIG. 7 is started.

FIG. 7 illustrates a program flow implemented in the server to determine whether sufficient demand to produce the work of art exists in accordance with preferred embodiments of the present invention. Once the order to purchase has been approved at block 700, the Current Order field 122 and Purchase/Preference Information 124 on the user record 71a, b, . . . or n is updated by the database interface 55. Thus, each decision to coproduce a work of art by the user is tracked in the unique user record 71a, b, . . . n. In addition, at block 710, the Number of Bids Received field 222 and the Purchaser Record field 224 on the project record 76a, b, . . . or n is updated by the database interface 55. The value of the Number of Bids Received is increased by the quantity of approved orders placed by the user, and the log of all the users who have placed an order for the work of art is kept track in the project record 76a, b, . . . or n. At block 715, the database interface 55 determines whether the number of bids received is greater than the number of bids needed by comparing the two fields Number of Bids Needed 220 and Number of Bids Received 222. If the number of bids received is less than the number of bids needed, then at block 720, a notice is sent to the user that the project will begin production by the date listed in the Cutoff Date field 226 or a refund will be automatically issued to the user credit card, and the logic of FIG. 7 is terminated. If the number of bids received exceeds the number of bids needed, the database interface 55 at block 725 determines whether the cutoff date has been reached by comparing the server's internal date clock with the date listed in the Cutoff Date field 226. If the cutoff date has been reached, then the database interface will know that the work of art has been already requested from the artist, and a message to the user is sent (at block 730) that the work of art will be shipped shortly after completion or if the work of art has already been produced that it will be shipped from existing inventory. On the other hand, if the cutoff date has not been reached, the database interface determines whether the work of art has been ordered from the artist by checking the Stock Info field 228 (at block 735). If the order to produce the work has not been issued already, the work is ordered at block 740 and the Stock Info field 228 of the project record 76a, b, . . . n is updated by the database interface 55 to reflect that the work of art has been ordered. However, regardless of whether the work of art has been previously ordered or not, the logic of FIG. 7 eventually terminates at block 730 since the number of bids received has exceeded the number of bids needed, triggering the artist obligation to produce the work of art based on the demand of the users. A message is sent to the user stating that the work of art will be shipped as soon as the work is completed and available for shipping.

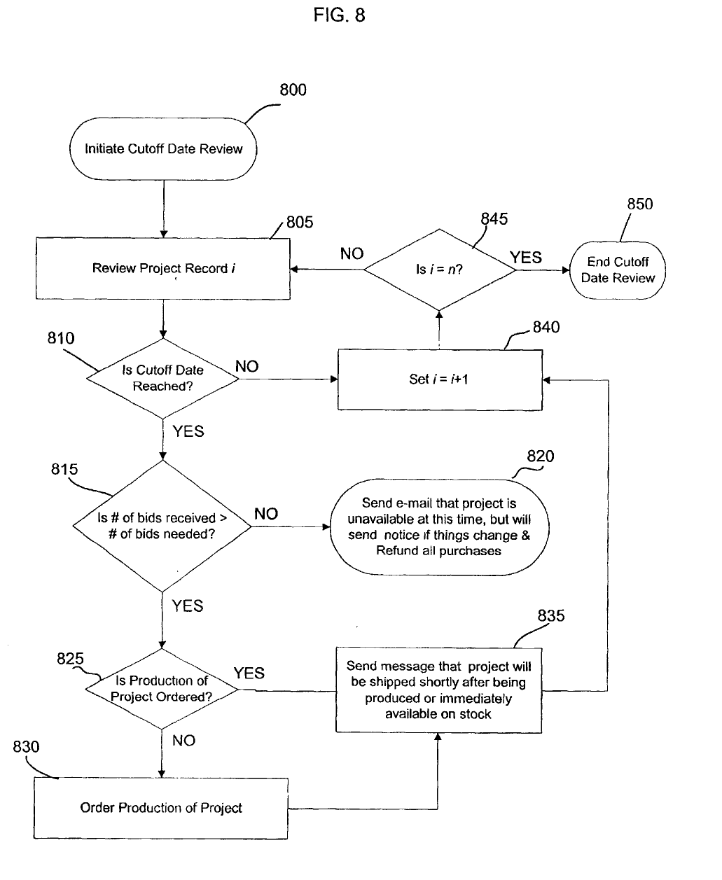

FIG. 8 illustrates an alternative program flow implemented in the server to determine whether to produce the work of art project in accordance with preferred embodiments of the present invention. At block 800, the database interface is scheduled to initiate a cutoff date review of the project records 76a, b, . . . n on a daily basis. The cutoff review begins by the database interface 55 checking the Cutoff Date field 226 on each individual project record 76a, b, . . . n (at block 805). Whether the cutoff date has been reached is determined by comparing the server's internal date clock with the date listed in the Cutoff Date field 226 (at block 810). If not, then database interface is set at block 840 to check the next project record. Before the next project record 76a, b, . . . n is reviewed, the database interface checks to see if all the project records have been checked already (at block 845). If all of the project records 76a, b, . . . n have been checked, the logic of FIG. 8 is terminated at block 850. Otherwise, the next project record 76a, b, . . . n is reviewed for its cutoff date. If the cutoff date has been reached for a particular project record 76a, b, . . . n, then the database interface 55 at block 815 determines whether the number of bids received is greater than the number of bids needed by comparing the two fields Number of Bids Needed 220 and Number of Bids Received 222. If not enough bids were received for the project by the cutoff date, then at block 820, a notice is sent to the user that the project is unavailable at this time, but may be available again at some future date. All orders for purchase are then refunded by crediting back the credit card for all users who have placed bids on the particular work of art as logged in the Purchaser Record field 224 of the project record 76a, b, . . . n. On the other hand, if the number of bids received exceeds the number of bids needed, the database interface determines whether the work of art has been ordered from the artist by checking the Stock Info field 228 (at block 825). If the order to produce the work has not been issued already, the work is ordered at block 830 and the Stock Info field 228 of the project record 76a, b, . . . n is updated by the database interface 55 to reflect that the work of art has been ordered. However, regardless of whether the work of art has been previously ordered or not, the logic of FIG. 8 terminates at block 835 if the number of bids received has exceeded the number of bids needed, triggering the artist obligation to produce the work of art based on the demand of the users. A message is sent to the user stating that the work of art will be shipped as soon as the work is completed and available for shipping.

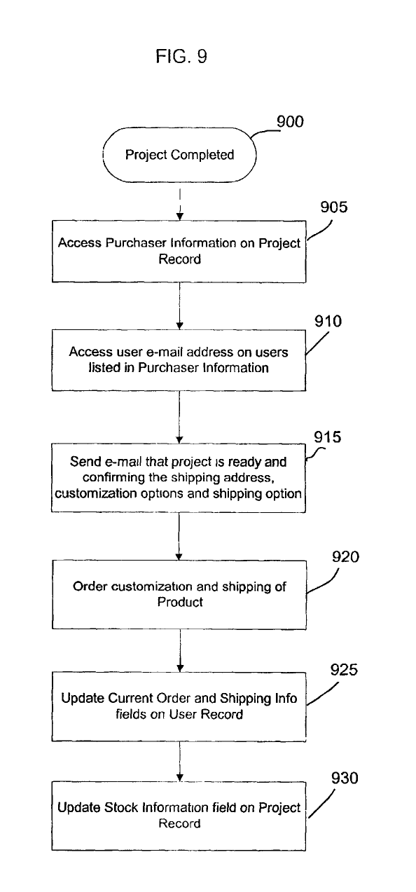

At some point, the work of art will be finished and ready for shipment. FIG. 9 illustrates a program flow implemented in the server to fulfill the Delivery Process in accordance with preferred embodiments of the present invention. Once the project is completed at block 900, the database interface 55 accesses the Purchaser Record field 224 (at block 905) to determine which users have ordered/coproduced the work of art At block 910, the database interface 55 cross references the data in the Purchase Record field 224 to access the E-mail address field 116 of all the users listed. At block 915, an e-mail is sent to all the users in Purchase Record field 224 stating that the project is ready and to confirm that information in the Name and Address field 118, Shipping Information field 126 and Customization Options field 128 is up to date and correct. The Customization Options field 128 records the way the user prefers to have the his/her name listed on the work of art as a coproducer (e.g. Joe Smith, et al.). The default setting of the Customization Option field 128 will be the name listed in the Name and Address field 118, but the user is allowed to customize certain aspects of the credits on the work of art ordered by the user to change the name (e.g. “Babyface Joe”). In preferred embodiments, the choice of font and color will also be available in the Customization Option field 128. In addition, in preferred embodiments, the user will have the option to change the shipping option. For example, the default setting may be three day UPS ground shipping, but the user will have the option to pay for a faster priority shipping such Federal Express by agreeing to pay for the additional shipping option by means of the credit card listed in the Credit Card Information field 120.

After providing an opportunity for the users to confirm the shipping and customization information, the database interface 55 at block 925 produces an order to the fulfillment department of the company on how to deliver the work of art to the purchasers including shipping and customization requirements. Once the order to fulfill has been given, the Current Order field 122 and Shipping Information field 126 on the user record 71a, b, . . . or n is updated by the database interface 55 at block 930. Thus, the tracking of the delivery process is recorded in the unique user record 71a, b, . . . n. In addition, at block 935, the Stock Information field 228 on the project record 76a, b, . . . or n is updated by the database interface 55. Thus, the number of works of art being manufactured is kept track in the project record 76a, b, . . . or n.

Those skilled in the art will appreciate that alternative embodiments exists from the description of the preferred embodiments without departing from the spirit and scope of the invention. The preferred embodiments may be implemented as a method, apparatus or article of manufacture using standard programming and/or engineering techniques to produce software, firmware, hardware, or any combination thereof. The term “article of manufacture” (or alternatively, “computer program product”) as used herein is intended to encompass one or more computer programs and data files accessible from one or more computer-readable devices, carriers, or media, such as a magnetic storage media, “floppy disk,” CD-ROM, a file server providing access to the programs via a network transmission line, holographic unit, etc. Of course, those skilled in the art will recognize that many modifications may be made to this configuration without departing from the scope of the present invention.

Preferred embodiments were shown in the context of network system, where all of the communications were performed through the Internet. However, in alternative embodiments, many of the functions can be performed by other means of communication such as telephone, fax, e-mail, etc. For example, the website owner may directly call the user to notify change in order status, confirming information, etc.

Preferred embodiments were described with respect to the database interface 55 performing the comparisons of the number of bids, cutoff date, etc. However, in alternative embodiments, some of the functions of the database interface may be implemented in a separate script program or eliminated altogether. Alternatively, the functions shown may be combined or split in any manner amongst one or more systems. Additionally, preferred embodiments were described with respect to the algorithm where the number of bids received exceeded the number of bids needed, however, alternatively, the algorithm can easily be set to when the number of bids received equals or is equals to or greater than the number of bids needed.

In addition, preferred embodiments described the user and project information as implemented as database records in a database table. However, the user and project information may be implemented in any format for maintaining object information, including spreadsheet, non-database table, etc. Thus, as used herein, the terms database record, database table, and database refer to any data structure known in the art for maintaining information on data objects, such as relational databases, non-relational databases, spreadsheets, ASCII text files, etc.

Therefore, the foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for producing a work of art over a network based on popular demand from a minimum number of bids from users, comprising:
generating a project database including at least one project record, wherein each project record indicates a work of art;
collecting a number of bids from users for the work of art associated with the at least one project record;
updating the at least one project record to record the number of bids for the work of art associated with the specific project record; and
ordering the work of art to be produced if the number of bids for the work of art associated with the at least one project record reaches the minimum number of bids.

2. The method of claim 1, further comprising
setting a cutoff date by when the number of bids must reach the number of minimum number of bids.

3. The method of claim 1, further comprising:
obtaining a pre-payment or a guarantee for payment for the work of art while collecting bids for the work of art associated with the at least one project record.

4. The method of claim 1, further comprising:
generating a user database including at least one user record, wherein each user record indicates a registered user.

5. The method of claim 2, further comprising:
determining whether the cutoff date has been reached for the at least one product record; and
cancelling the work of art associated with the at least one product record if the cutoff date has been reached and the number of bids for the work of art associated with the project record does not reach the minimum number of bids.

6. The method of claim 1, further comprising:
customizing the work of art associated the project record for each user if the number of bids for the work of art associated with the at least one project record reaches the minimum number of bids.

7. The method of claim 1, wherein collecting a number of bids from users for the work of art associated with the at least one project record is performed over an Internet.

8. The method of claim 4, further comprising:
transmitting over the network an input page in which the user enters information about interest and preferences of user;
receiving the input page with the information entered by the user; and
recording the information in the at least one user record associated with the user.

9. The method of claim 2, further comprising:
determining whether the cutoff date has been reached for the at least one product record; and
collecting a number of bids from users for the work of art associated with the at least one project record until the cutoff date has been reached.

10. A system for producing a work of art over a network based on popular demand from a minimum number of bids from users, comprising:
means for generating a project database including at least one project record, wherein each project record indicates a work of art;
means for collecting a number of bids from users for the work of art associated with the at least one project record;
means for updating the at least one project record to record the number of bids for the work of art associated with the specific project record; and
means for ordering the work of art to be produced if the number of bids for the work of art associated with the at least one project record reaches the minimum number of bids.

11. The system of claim 10, further comprising
means for setting a cutoff date by when the number of bids must reach the number of minimum number of bids.

12. The system of claim 10, further comprising:
means for obtaining a pre-payment or a guarantee for payment for the work of art while collecting bids for the work of art associated with the at least one project record.

13. The system of claim 10, further comprising:
means for generating a user database including at least one user record, wherein each user record indicates a registered user.

14. The system of claim 11, further comprising:
means for determining whether the cutoff date has been reached for the at least one product record; and
means for cancelling the work of art associated with the at least one product record if the cutoff date has been reached and the number of bids for the work of art associated with the project record does not reach the minimum number of bids.

15. The system of claim 10, further comprising:
means for customizing the work of art associated the project record for each user if the number of bids for the work of art associated with the at least one project record reaches the minimum number of bids.

16. The system of claim 10, wherein collecting a number of bids from users for the work of art associated with the at least one project record is performed over an Internet.

17. The system of claim 13, further comprising:
means for transmitting over the network an input page in which the user enters information about interest and preferences of user;
means for receiving the input page with the information entered by the user; and
means for recording the information in the at least one user record associated with the user.

18. The system of claim 11, further comprising:
means for determining whether the cutoff date has been reached for the at least one product record; and
means for collecting a number of bids from users for the work of art associated with the at least one project record until the cutoff date has been reached.

19. A program for producing a work of art over a network based on popular demand from a minimum number of bids from users, comprising a computer usable media including at least one computer program embedded therein that is capable or causing at least one computer to perform:
generating a project database including at least one project record, wherein each project record indicates a work of art;
collecting a number of bids from users for the work of art associated with the at least one project record;
updating the at least one project record to record the number of bids for the work of art associated with the specific project record; and
ordering the work of art to be produced if the number of bids for the work of art associated with the at least one project record reaches the minimum number of bids.

20. The program of claim 19, further performing
setting a cutoff date by when the number of bids must reach the number of minimum number of bids.

21. The program of claim 19, further performing:
obtaining a pre-payment or a guarantee for payment for the work of art while collecting bids for the work of art associated with the at least one project record.

22. The program of claim 19, further performing:
generating a user database including at least one user record, wherein each user record indicates a registered user.

23. The program of claim 20, further performing:
determining whether the cutoff date has been reached for the at least one product record; and
cancelling the work of art associated with the at least one product record if the cutoff date has been reached and the number of bids for the work of art associated with the project record does not reach the minimum number of bids.

24. The program of claim 19, further performing:
customizing the work of art associated the project record for each user if the number of bids for the work of art associated with the at least one project record reaches the minimum number of bids.

25. The program of claim 19, wherein collecting a number of bids from users for the work of art associated with the at least one project record is performed over an Internet.

26. The program of claim 22, further performing:
transmitting over the network an input page in which the user enters information about interest and preferences of user;
receiving the input page with the information entered by the user; and
recording the information in the at least one user record associated with the user.

27. The program of claim 20, further performing:
determining whether the cutoff date has been reached for the at least one product record; and
collecting a number of bids from users for the work of art associated with the at least one project record until the cutoff date has been reached.
